(19) United States
(12) Patent Application Publication
(10) Pub. No.: US 2017/0208940 A1
(43) Pub. Date: Jul. 27, 2017

(54) CABINET FOR STORING FOOD TRAY ITEMS

(71) Applicant: Jean-Pierre BOUDREAULT, Carignan (CA)

(72) Inventor: Jean-Pierre BOUDREAULT, Carignan (CA)

(21) Appl. No.: 15/415,134

(22) Filed: Jan. 25, 2017

(30) Foreign Application Priority Data
Jan. 25, 2016 (CA) 2918969

(51) Int. Cl. A47B 71/00; A47B 81/00; A47J 39/00; A47B 88/975; A47F 1/12; A47B 31/02; A47B 75/00

(52) U.S. Cl. CPC A47B 71/00; A47B 31/02; A47B 81/00; A47B 75/00; A47B 88/975; A47F 1/125; A47J 39/00; A47B 2031/002

(57) ABSTRACT

The cabinet is for use at a food tray assembly station. It includes a repositioning system for repositioning food tray items disposed in a storage compartments on a shelf. This system includes a transversally-disposed push plate that is slidably engaged inside a corresponding one of the storage compartments and that is longitudinally movable along the food tray item path. It also includes an elongated and longitudinally-disposed pull strip that is slidably mounted inside the corresponding one of the storage compartments. A one-way locking device is interposed between the push plate and the pull strip to incrementally move the push plate in a forward direction upon moving the pull strip from the retracted position towards the extended position. The system can reposition a row of food tray items quickly and efficiently.

### CROSS-REFERENCE TO PRIOR APPLICATION

The present case claims the benefit of Canadian patent application No. 2,918,969 filed on 25 Jan. 2016, which is hereby incorporated by reference in its entirety.

### TECHNICAL FIELD

The technical field relates generally, among other things, to cabinets for storing food tray items and to food storage compartments.

### BACKGROUND

The assembly of individual food trays containing food products and the necessary tableware, all of which are referred to hereafter as food tray items, is routinely carried out in institutions, such as hospitals and rest homes, in commercial kitchens and in a number of other facilities. Various systems and methods have been suggested to facilitate the work of the persons involved in these tasks, which persons are referred to hereafter as attendants. Generally, one or more attendants load one or more food tray items on each food tray based on specific guidelines or instructions, and there are often several different possible combinations to customize trays so as to match the needs of various persons to which these food trays will be presented. The food trays can be assembled at a single station or after going through a succession of stations, depending on the implementations. For the sake of efficiency, and particularly when the number of food trays to assemble in a relatively short time period for each meal is quite large, the different food tray items at a food tray assembling station(s) must be readily available to and within easy reach of the attendant. Reducing the assembly time to a bare minimum is often highly desirable.

Many food tray items at a food tray assembling station can be stored in one or more cabinets. Each cabinet generally has a plurality of superposed shelves and each shelf can include one or more rows of food tray items. These rows extend between the rear of the cabinet towards the front end. The front door or doors of the cabinet are often left opened when assembling a large number of trays. The attendant assigned to the station sits and/or stands in front of the cabinet or cabinets and the trays slide in succession in front of the attendant to keep everything in close proximity. Some cabinets can also include food tray items in storage spaces below what supports the trays. The attendant takes to required food tray items by hand and put them on each tray where they are needed. A cabinet can include refrigerated and/or heated zones, depending on the implementations. Still, in some implementations, at least one zone or even the entire cabinet can be devoid of any cooling/heating arrangement.

Food tray items stored on cabinet shelves often have only a minimal space between them and each shelf may include a plurality of compartments in which the food tray items are disposed in rows. Optimizing the space can improve efficiency and it is generally ergonomically desirable.

When a food tray item from a row on a shelf is needed, the attendant at a station typically takes the first one on the row, thus the one currently located at the foremost edge of the shelf. However, once taken, the next food tray item on the same row will then be further away from the foremost edge, making it more difficult and even sometime almost impossible for the attendant to reach it by hand unless the remaining food tray items of the row are repositioned. Different arrangements were proposed over the years to address this issue. Among other things, shelves can be inclined downwards towards the foremost edge so that the food tray items can slide by gravity. An example of an arrangement including inclined shelves is shown for instance in U.S. Pat. Appl. Publ. No. US 2003/0233814 A1 dated 25 Dec. 2003.

Other arrangements involve having drawer-like shelves that can be pulled out to facilitate access, or spring-loaded push plates continuously urging the food tray items towards the foremost edge. These various arrangements, however, are not always entirely satisfactory. For instance, the maximum number of inclined shelves that can be installed within a given cabinet for dispensing food tray items is often smaller than the maximum number of horizontally-disposed shelves that can fit within the same cabinet space for dispensing the same food tray items, particularly if the angle of the inclined shelves is relatively steep. Using drawer-like shelves is not always desirable since it generally requires repetitively moving back and forth the weight of a whole content of a shelf or of a section thereof, in addition to the weight of the corresponding hardware. Reaching food tray items located at the rear end can still be difficult. As for spring-loaded push plates, they are not suitable for many food tray items, particularly the ones that are lightweight and/or that can easily overlap one another. One example would be a row of small empty plates or a row of small empty coffee cups.

Therefore, there is still room for further improvements in this area of technology.

### SUMMARY

The proposed concept involves a new approach in the design of food holding cabinets for use at a station where individual food trays are assembled, and also in the design of storage compartments in which food tray items are provided for use at such station.

In one aspect, there is provided a cabinet for use at a food tray assembly station, the cabinet including: a cabinet housing having a base portion and a top portion located above the base portion, the top portion including at least one front opening; a plurality of superposed substantially horizontal shelves provided inside the top portion, each shelf having at least one elongated storage compartment configured to receive a plurality of food tray items that are longitudinally disposed in a single row along a corresponding food tray item path ending at a foremost edge of the shelf; a repositioning system provided in at least one of the storage compartments, the repositioning system including: a transversally-disposed push plate that is slidably engaged inside a corresponding one of the storage compartments and that is longitudinally movable along the food tray item path; an elongated and longitudinally-disposed pull strip that is slidably mounted inside the corresponding one of the storage compartments and that is movable between an extended position and a retracted position; and a one-way locking device interposed between the push plate and the pull strip to incrementally move the push plate in a forward direction upon moving the pull strip from the retracted position towards the extended position, the one-way locking device bringing the push plate and the pull strip in a force-transmitting engagement only when the pull strip is drawn in the forward direction and automatically releasing the force-transmitting engagement when the pull strip is moved backward towards the retracted position.

Details on the various aspects, features and advantages of the proposed concept can be found in the following detailed description and the appended figures.

### BRIEF DESCRIPTION OF THE FIGURES

FIG. 1 is a front isometric view of an example of a cabinet in which the proposed concept can be implemented.

FIG. 2 is a rear isometric view of the cabinet illustrated in FIG. 1.

FIG. 3 is a front isometric view of another example of a cabinet in which the proposed concept can be implemented.

FIG. 4 is a rear isometric view of the cabinet illustrated in FIG. 3.

FIG. 5 is a front isometric view of another example of a cabinet in which the proposed concept can be implemented.

FIG. 6 is a rear isometric view of the cabinet illustrated in FIG. 5.

FIG. 7 is a front isometric view of another example of a cabinet in which the proposed concept can be implemented.

FIG. 8 is a rear isometric view of the cabinet illustrated in FIG. 7.

FIGS. 9 to 13 are schematic top views illustrating an example depicting how the repositioning system works.

FIG. 14 is an isometric view of an example of a storage compartment having a repositioning system.

FIG. 15 is an isometric view illustrating the storage compartment of FIG. 14 from another angle.

FIG. 16 is an end view of the storage compartment of FIG. 14 but without the repositioning system.

FIG. 17 is an isometric view illustrating the push plate and the one-way locking device of the repositioning system shown in FIG. 14.

FIG. 18 is an isometric view illustrating the pull strip of the repositioning system shown in FIG. 14.

### DETAILED DESCRIPTION

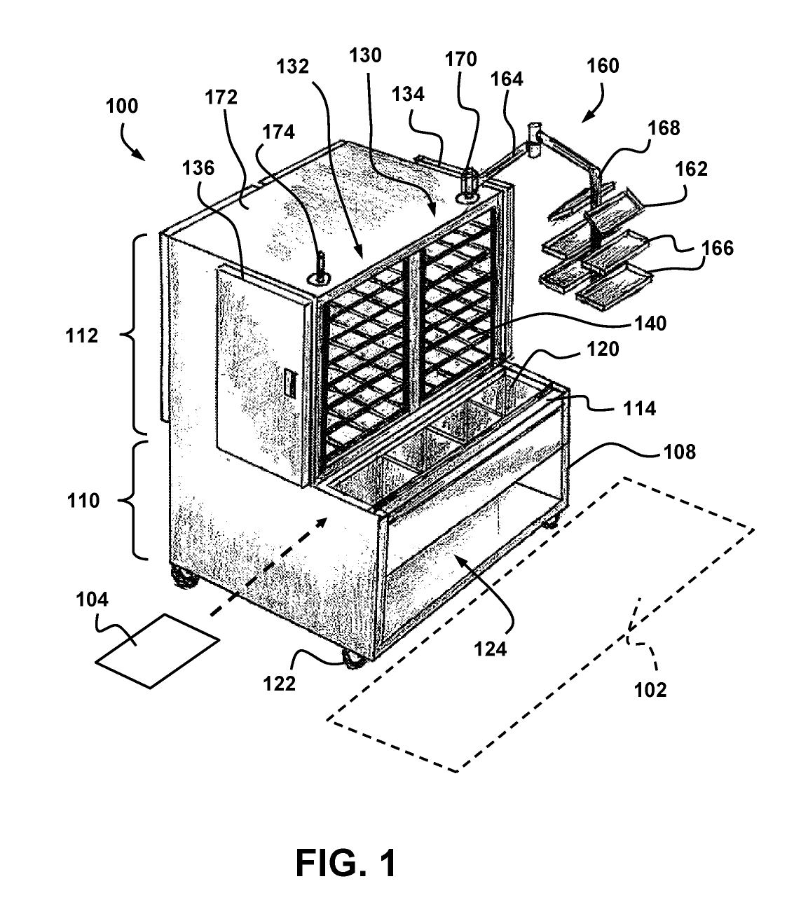

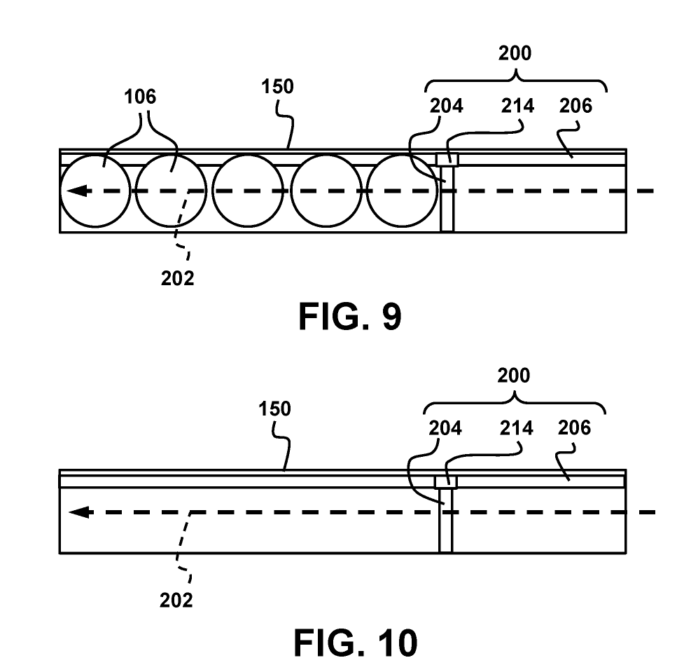

FIG. 1 a front isometric view of an example of a cabinet 100 in which the proposed concept can be implemented. This cabinet 100 can be part of an assembly line and/or be used as a standalone equipment. It provides a multitude of storage spaces to store many different food tray items that can be loaded onto a food tray by a person, hereafter called an attendant, sitting and/or standing in front of the cabinet 100. The area located in front of the cabinet 100 can be referred to as a food tray assembling station. The food tray assembling station is schematically illustrated in FIG. 1 at 102. A generic example of a food tray is also schematically illustrated on FIG. 1 at 104 and a generic example of a food tray item is schematically illustrated in FIG. 9 at 106.

The food tray assembling station 102 can be provided in a kitchen and/or in a galley and/or at any other location where it may be useful. The cabinet 100 can be used as a static equipment and/or be used as a wheeled or otherwise movable equipment, for instance as a food service cart or the like. Other variants are possible as well.

It should be noted at this point that the main goal of the cabinet 100 is to store food tray items in the context of a food tray assembling station. Thus, the words such as “store”, “storing” and other similar words refer to the fact that food items are loaded inside the cabinet 100 in order to be readily available when food trays are assembled. Each food tray item will generally be stored inside the cabinet 100 for only a very short time period. The food tray items 106 to be stored include food products and the necessary tableware. Since the food products are put in the cabinet 100 in order to be picked up, as opposed for instance to being taken from a cooking pan or pot, the food products will be mostly precooked and/or otherwise processed foods that are individually packaged and/or put on or in a relatively small container such as a bowl, a plate, etc. Some food products may also be provided without another package or container, such as fresh fruits or vegetables that can be put directly in a storage container. This includes for instance apples or peaches, to name just a few. Beverages are considered to be food products. To save time, small measured portions of beverages can be poured into glasses and/or cups, for instance. The cabinet 100 may also sometimes have rows with items that have no food product yet. One example would be a tea or coffee cup and the corresponding plate.

In the example illustrated in FIG. 1, the cabinet 100 includes a cabinet housing 108 having a base portion 110 that is larger than the top portion 112. The top portion 112 has a front opening. The base portion 110 of this example extends at the front side, i.e. is larger than the top portion 112, and this creates a front top counter surface area 114 on which the tray or trays 104 can be placed during the assembling process. The front top counter surface area 114 is part of the working space at the food tray assembling station 102. Each food tray 104 will be supported by the horizontal lateral surfaces surrounding individual cases 120 located immediately below the front top counter surface area 114. There are four cases 120 in the illustrated example but other configurations are also possible. Each case 120 is opened at the top and can contain food tray items 106 as well. The illustrated cabinet 100 is also mounted on sets of caster wheels 122 and includes a bottom compartment 124 underneath the cases 120. These various features are optional and variants are possible as well. For instance, to name just a few, one can design the cabinet 100 without a front top counter surface area 114 and/or without the individual cases 120.

The main external walls of the cabinet 100 can be made of materials such as stainless steel. Stainless steel is generally a very suitable material for these walls since it is easy to clean and very durable. Nevertheless, other materials are possible as well. Some or even all of the walls can include a thermal insulation when this may be useful.

The cabinet 100 in the example illustrated in FIG. 1 also includes two adjacent shelf sections 130, 132, namely a right shelf section 130 and a left shelf section 132, which are located within the space inside the top portion 112. Each shelf section 130, 132 includes a plurality of superposed substantially horizontal shelves 140. The shelves 140 are vertically spaced apart from one another.

The vertical spacing may be constant or not. The shelves 140 in the illustrated example are subdivided into a plurality of individual storage compartments 150 in which food tray items 106 will be gathered and lined up to form a row. The food tray items 106 will be ready to be picked up one by one by the attendant from the cabinet 100. A same kind of food tray item 106 can be stored in more than one row but a same row will generally have the same kind of food tray items 106 unless, for instance, they were loaded using a predetermined sequence matching corresponding instructions to be followed by the attendant. Other variants are possible as well.

In the example of FIG. 1, the two shelf sections 130, 132 can be part of a same undivided interior space of the cabinet housing 108 or they can be two separate spaces with a partition wall between them. A partition wall can be useful, for instance, to keep the shelf sections 130, 132 at different temperatures and/or for other reasons. The cabinet 100 can include refrigerated and/or heated zones, depending on the needs. The refrigerated zones can be over and/or below the water freezing temperature. In other implementations, at least one part or even the entire cabinet 100 can be devoid of any cooling/heating arrangement. When using refrigerating and/or heating systems, many or even all of the associated components, such as the coils, the compressor, the air ducts, etc., can be provide inside the cabinet 100. It is also possible to use external equipment together with components inside the cabinet 100.

The front openings of the shelf sections 130, 132 in the illustrated example can be closed by opposite front doors 134, 136 and each front door 134, 136 is made of a single panel. These doors 134, 136 can be pivoted outwards to open them and they can also slide backwards along rails provided on the corresponding side walls of the cabinet 100. The doors 134, 136 can be moved out of the way and they will not interfere with the work of the attendant. Other door configurations and arrangements are possible as well. Still, one can also design a cabinet 100 without doors or even use doors that are completely detached and stowed away from the cabinet 100 when opened.

Each shelf 140 of the cabinet 100 can receive multiple storage compartments, each defining a food tray item path extending from a rear end to a foremost edge of the shelf 140. The shelves 140 have a depth suitable for storing a many food tray items per row, thus per storage compartment. The foremost edge of each shelf 140 is exposed when the front doors 134, 136 of the cabinet 100 are opened.

When refrigerated zones are provided inside the cabinet 100, keeping a relatively tight space between the superposed shelves 140 can be desirable to keep the temperature down inside the cabinet 100 when the front doors 134, 136 remain open for long time periods. The presence of the food tray items 106 near the foremost edge of the shelves 140 will help keeping the colder air inside the cabinet 100.

As can be seen, the cabinet 100 of FIG. 1 also includes an auxiliary dispensing unit 160 having a support 162 suspended at the end of an articulated arm 164. The support 162 includes a plurality of receptacles 166 disposed around a central post 168 to hold one or more items, such as utensils or the like, or even small food products, in close proximity of the attendant. They can also be moved around the cabinet 100 as needed or to facilitate cleaning. The receptacles 166 can be holding trays, baskets and/or other kinds of container. The illustrated arm 164 has a plurality of juxtaposed segments and the first one is pivotally mounted around a peg 170 projecting from the top wall 172 of the cabinet 100, at the right corner near the front side thereof in the example. There is also a similar peg 174 at the left front corner to receive the same auxiliary dispensing unit 160 or to receive a second auxiliary dispensing unit, if required. The auxiliary dispensing unit 160 is optional and it can also be configured differently, for instance with only one receptacle 166 and/or with a one-piece arm 164. Other variants are possible as well.

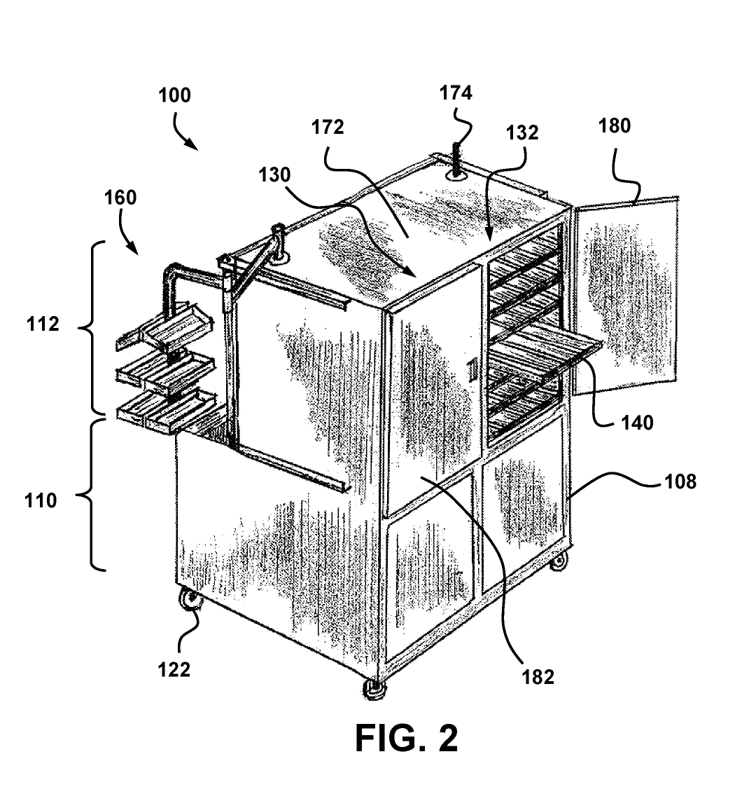

FIG. 2 is a rear isometric view of the cabinet 100 illustrated in FIG. 1. As can be seen, the rear side of the shelf sections 130, 132 of this cabinet 100 has two rear openings. These two rear openings can be closed by two rear doors 180, 182, each made of a single panel. These rear doors 180, 182 are normally closed when the trays are being assembled, but the rear doors 180, 182 could be left open or even be entirely omitted in some implementations. Other variants are possible as well.

FIG. 2 also shows that the shelves 140 of this cabinet 100 are mounted on rails or using other suitable arrangement, and they can be at least partially pulled out from the rear side. Depending on the implementation, they can normally be pulled out over a given distance, for instance ⅔ of their length, and/or be entirely removable from inside of the cabinet 100. When designed to be only partially retractable, the shelves 140 can nevertheless be made entirely removable for cleaning purposes or for reconfiguration. The word “normally” refers to the routine use of the shelves 140.

The shelves 140 of the illustrated cabinet 100 are designed to be loaded from the rear side. This allows, among other things, to resupply the cabinet 100 while the tray assembling operations are still ongoing using the remaining contents. The top portion 112 of the cabinet 100 is also flush at the rear with the base portion 110, and this can facilitate access. Additional and/or newer supplies of food tray items 106 can be loaded by placing them individually and/or by inserting one or more storage compartments already filled with the food tray items 106. A shelf 140 can thus include storage compartments that are individually removable and/or that are removable as part of a group of adjacent storage compartments attached to one another, thereby forming a cassette-like platform to be put or pushed on the shelf 140, or even forming most of the shelf 140. Using preloaded cassettes can greatly facilitate the handling of the supplies. Nevertheless, one can design a cabinet 100 that has only non-retractable and non-slidable shelves 140. One can also design a cabinet 100 where the food tray items 106 are loaded at the front of the cabinet 100, or that can be loaded from both sides.

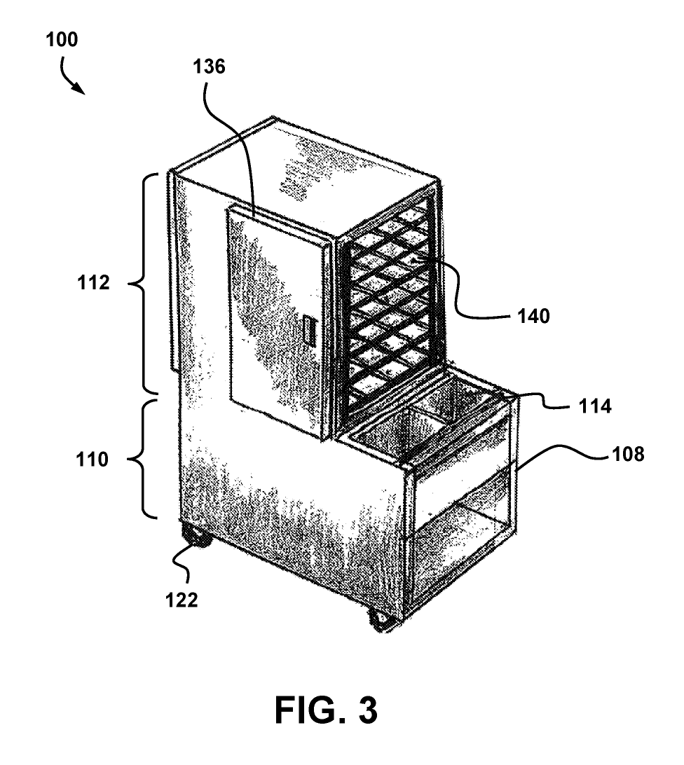

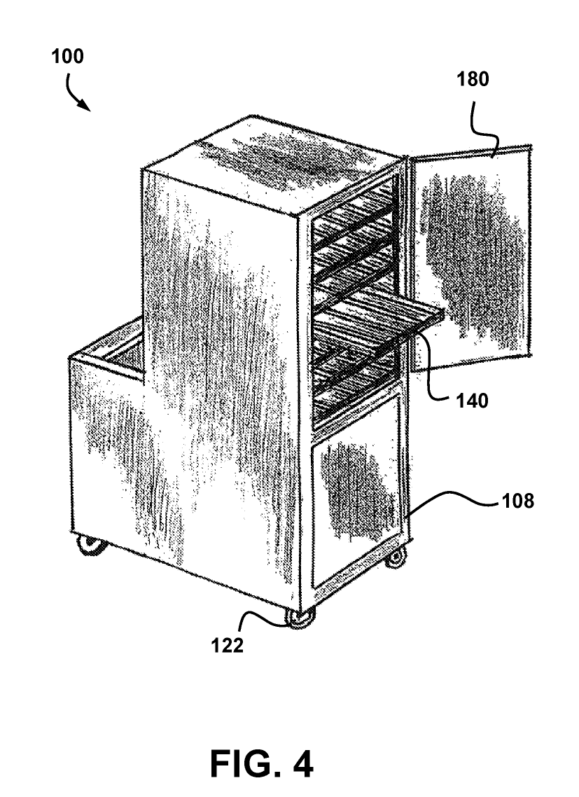

FIG. 3 is a front isometric view of another example of a cabinet 100 in which the proposed concept can be implemented. This cabinet 100 is half the width of the one illustrated in FIG. 1. FIG. 4 is a rear isometric view of the cabinet 100 illustrated in FIG. 3.

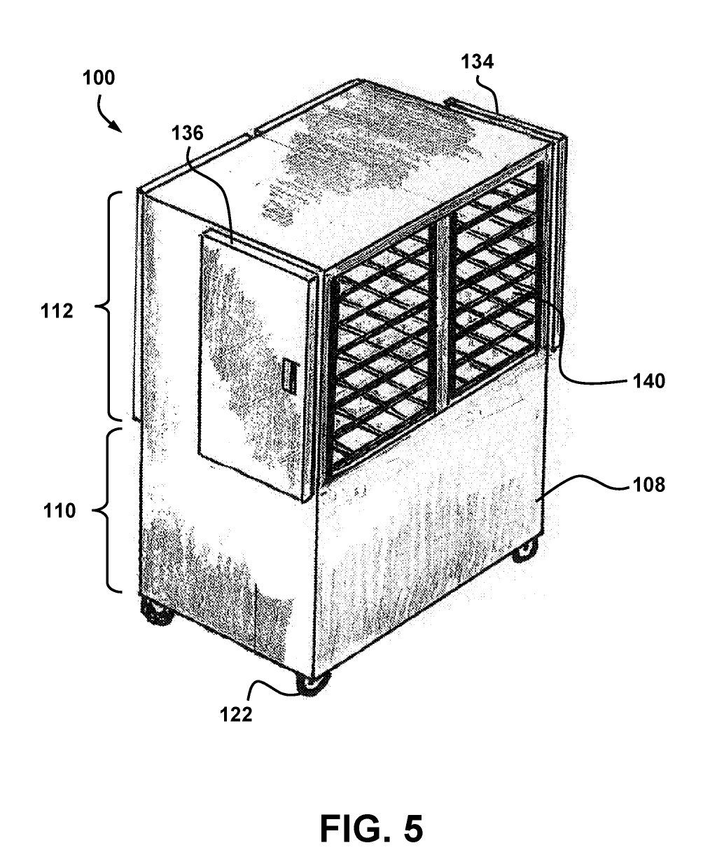

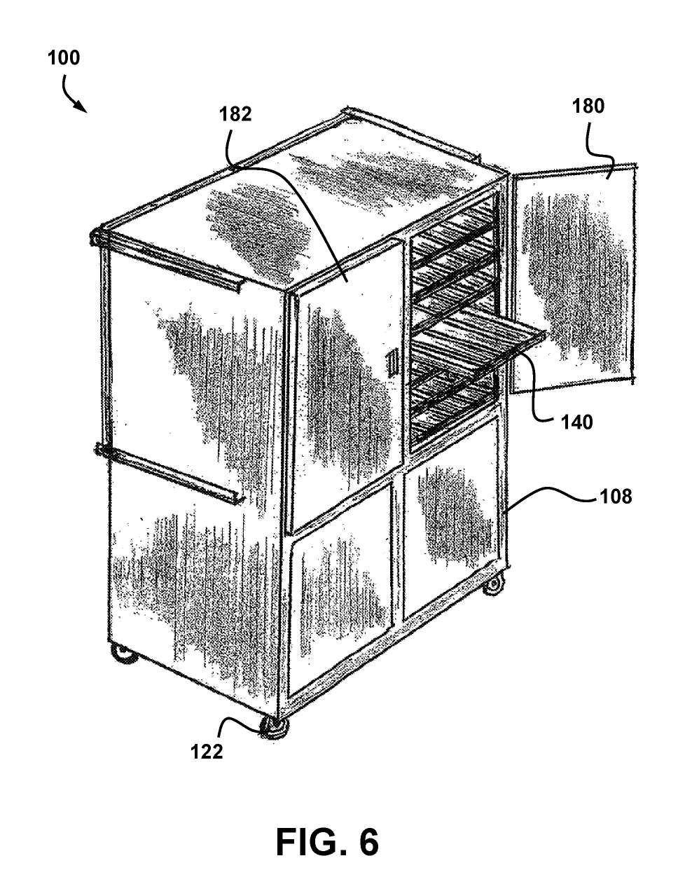

FIG. 5 is a front isometric view of another example of a cabinet 100 in which the proposed concept can be implemented. This cabinet 100 is similar to the one illustrated in FIG. 1 but it does not have a larger base portion 110. FIG. 6 is a rear isometric view of the cabinet 100 illustrated in FIG. 5.

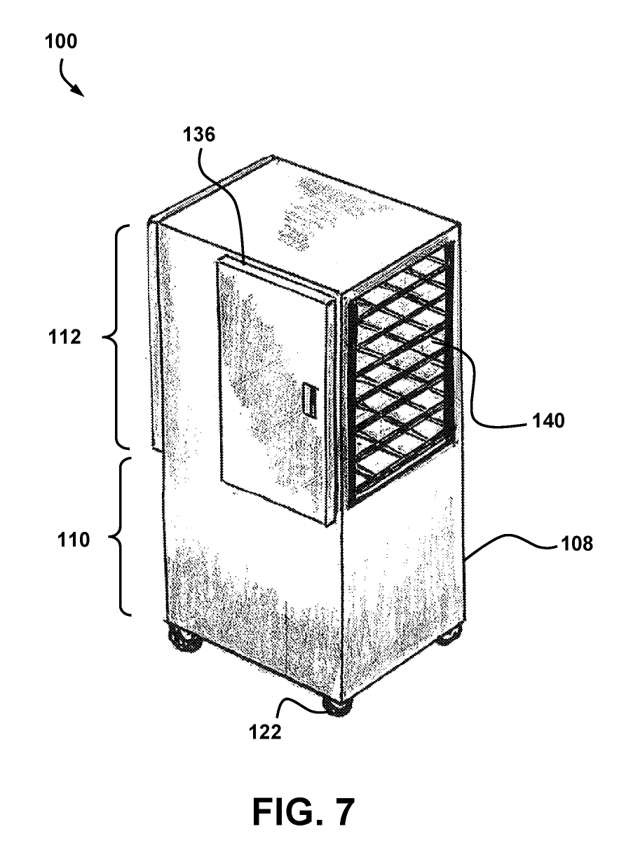

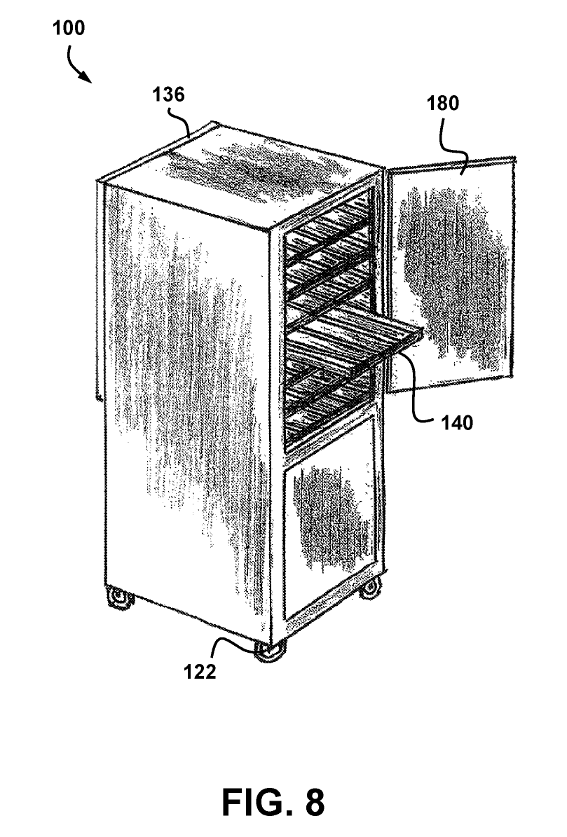

FIG. 7 is a front isometric view of another example of a cabinet 100 in which the proposed concept can be implemented. This cabinet 100 is half the size of the one illustrated in FIG. 5. FIG. 8 is a rear isometric view of the cabinet 100 illustrated in FIG. 7.

It should be noted that although FIGS. 1 to 8 illustrate different examples for the cabinet 100, these are not the only possible designs and many other designs can be devised as well.

Unlike prior arrangements where food tray items 106 move by gravity towards the foremost edge of a shelf along an inclined slope or where food tray items 106 are pushed by using a pre-loaded spring, the cabinet 100 includes at least one storage compartment 150 having a repositioning system 200 designed to be manually operated by the attendant. The cabinet 100 will generally include a multitude of these storage compartments 150. For the sake of simplicity, the rest of the present description is made using an example where each shelf 140 of the cabinet 100 has multiple storage compartments 150 disposed in juxtaposition, each including a corresponding repositioning system 200. Once again, variants are possible as well.

FIGS. 9 to 13 are schematic top views illustrating how the repositioning system 200 works. FIG. 9 is a schematic top view showing one storage compartment 150 in which a number of generic food tray items 106 are disposed in a row. Arrow 202 depicts the food tray item path, i.e. towards the front side of the cabinet 100. FIG. 9 also shows the push plate 204 located at the trailing end of the row, thus behind the last one of the food tray items 106.

FIG. 10 is a view similar to FIG. 9 but where the food tray items 106 were omitted for the sake of illustration. This figure shows the entire length of the pull strip 206. As can be seen, the pull strip 206 is both elongated and relatively narrow. The pull strip 206 is in a retracted position in FIGS. 9 and 10. The pull strip 206 is slidably disposed in a corner of the storage compartment 150 in this example. Variants are possible as well. For instance, the pull strip 206 can be placed inside a bottom groove extending on the bottom wall of the storage compartment 150. This groove can be positioned at the center or elsewhere. Other variants are also possible.

FIG. 11 is a schematic top view showing the pull strip 206 being moved towards its extended position. This happens when the front end of the pull strip 206 is manually pulled forward by the attendant. The pull strip 206 is then partially drawn out and it will then extend beyond the foremost edge of the storage compartment 150. The repositioning system 200 includes a one-way locking device 214 that creates a force-transmitting engagement between the push plate 204 and the pull strip 206 but only when the pull strip 206 is moved in the forward direction 210, which direction is depicted in FIG. 11 using an arrow.

In use, the attendant accesses and removes food tray items 106 to assemble the food trays 104 as required. Whenever a food tray item 106 is taken from the storage compartment 150 and there are other ones in it, the remaining item or items can be quickly, conveniently and easily repositioned closer to the foremost edge using the repositioning system 200. The repositioning system 200 can be used immediately after putting an item on a tray and/or to bring closer an item that must be immediately loaded on a tray. The last of the food tray items 106 of the row will be pushed by the front side of the push plate 204 and this last item will then push on any other food tray items 106 of the same row. The attendant will generally move the push plate 204 over a distance that substantially corresponds to the spacing between each food tray item 106 stored therein. The attendant does not necessarily need to move the pull strip 206 all the way up to the extended position (i.e. maximum extended position) every time. The attendant can be move the push plate 204 in multiple strokes, for instance using one quick pull movement before pushing the pull strip 206 backward, and then immediately adjusting the position of the push plate 204 with a shorter pulling motion of the pull strip 206, followed by moving the pull strip 206 to be retracted position. Other methods are possible as well.

FIG. 12 is a view similar to FIG. 11 but shows the pull strip 206 being moved back towards its retracted position after being pulled in the forward direction. The rearward direction 212 is depicted in FIG. 12 using arrow. As can be seen, the push plate 204 is at the same position it was in FIG. 11 because of the presence of the one-way locking device 214. FIG. 13 shows the pull strip 206 once back entirely at its initial retracted position.

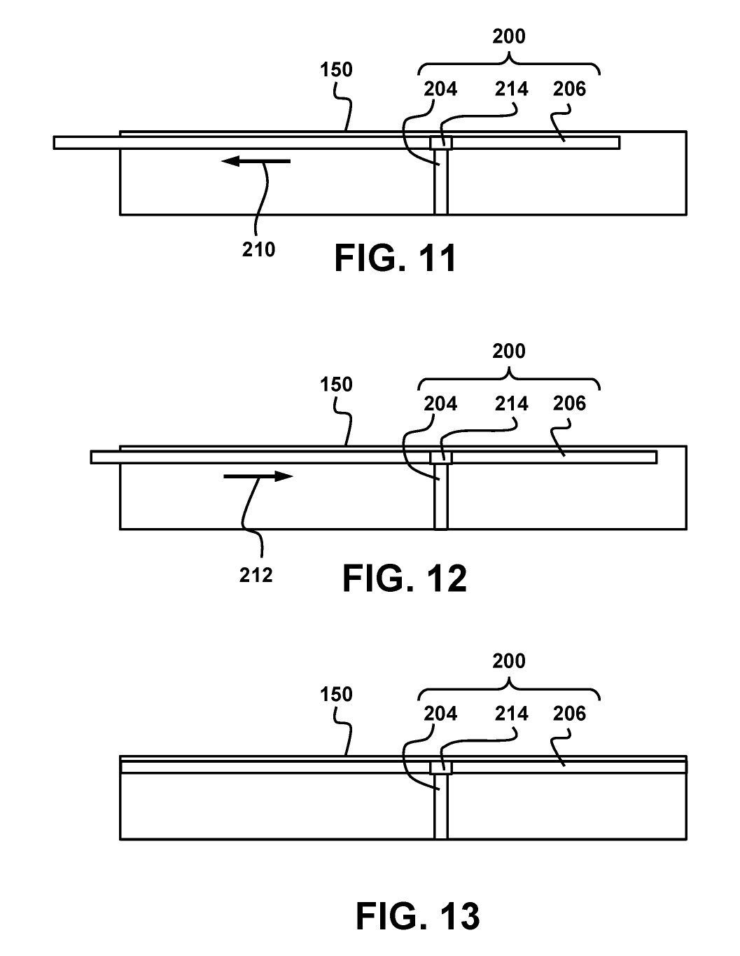

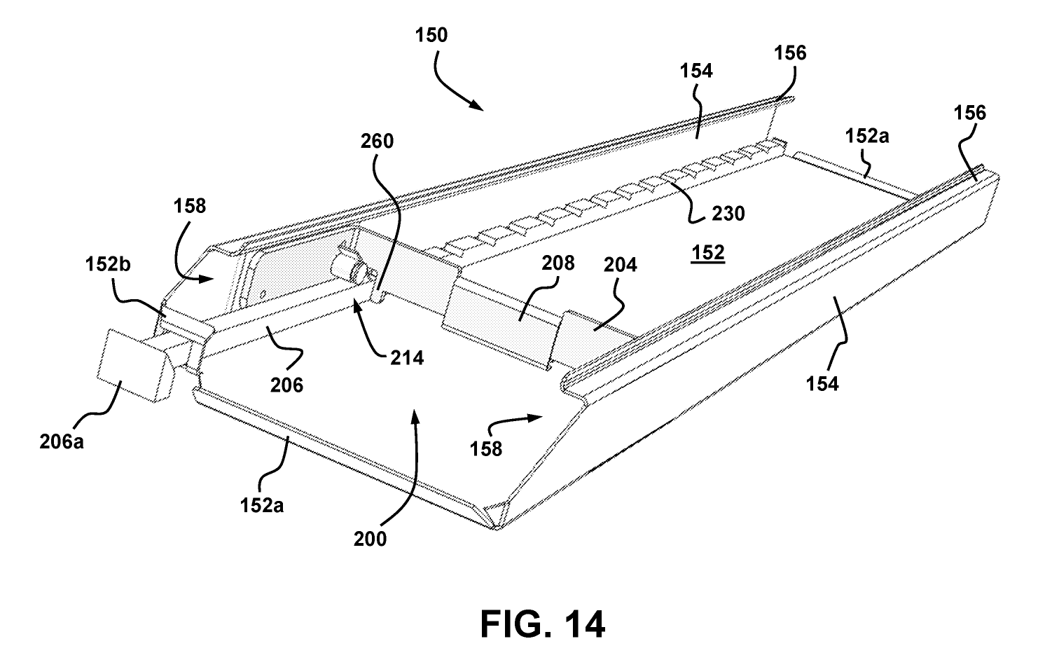

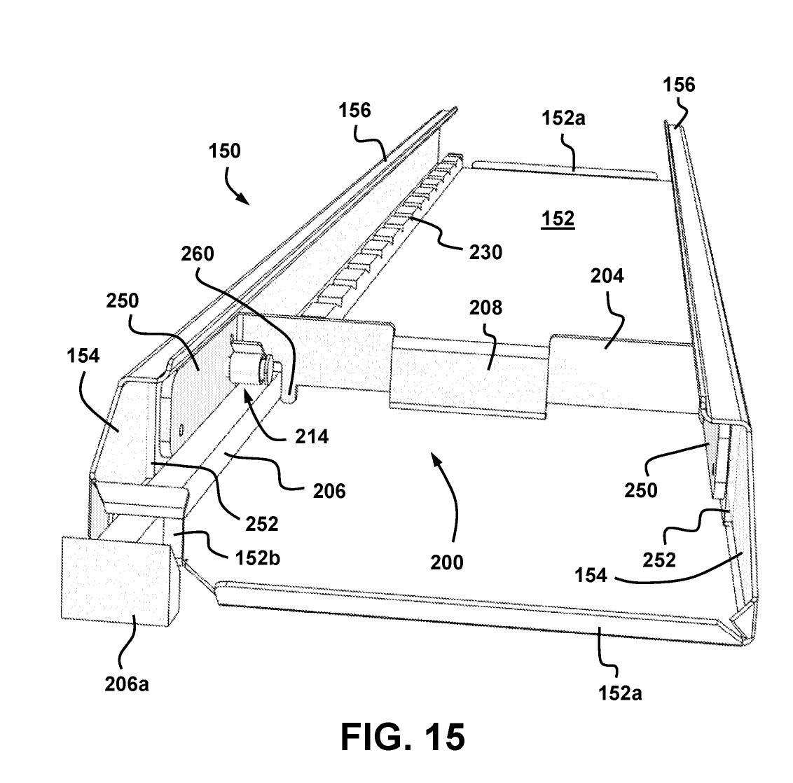

FIG. 14 is an isometric view of an example of a storage compartment 150 having a repositioning system 200. FIG. 15 is an isometric view illustrating the storage compartment 150 of FIG. 14 from another angle. FIG. 16 is an end view of the storage compartment 150 of FIG. 14 but, for the sake of illustration, without the repositioning system 200. These figures show an actual example of an implementation for the storage compartment 150 in accordance with the proposed concept. Other designs are possible as well.

The illustrated storage compartment 150 has a rectangular cross section. It is essentially opened at the top and at both ends. The interior surface of its bottom wall 152 is flat. Small slanted flanges 152a are provided at opposite edges in the illustrated implementation. These flanges 152a are used as stoppers but also to increase the torsional rigidity of the storage compartment 150. The pull strip 206 includes an enlarged front knob 206a to facilitate the handling. There is also a guiding member 152b at the front edge for guiding the front section of the pull strip 206. This guiding member 152b defines an opening through which the pull strip 206 is inserted. The guiding member 152b is positioned slightly behind the front edge of the storage compartment 150 and the bottom wall 152 is cut in front of the guiding member 152b to further facilitate the finger contact with the front knob 206a. These features can be very useful but can also be omitted in some implementations. Variants are possible.

The illustrated storage compartment 150 has opposite side walls 154 that are perpendicular to the bottom wall 152. The interior surface of these side walls 154 are also flat. There is also a narrow top ledge 156 that extends perpendicularly and inwards along the upper edge of each side wall 152. The top ledges 156, along with the bottom wall 152 and the side walls 154, create two lateral guiding channels 158 that will be used for guiding movements of the push plate 204 and keeping it in position inside the storage compartment 150. Variants are possible as well.

Each top ledge 156 in the illustrated example has an upwardly-projecting portion 156a. The top ledges 156 and their upwardly-projecting portions 156a increase the torsional rigidity of the storage compartment 150. The two upwardly-projecting portions 156a can also be useful for centering the storage compartment 150 once put inside its corresponding shelf 140. For instance, the shelf 140 can include multiple track-like arrangements disposed side-by-side, each having two opposite C-shaped holders 142 of the sides to secure a corresponding one of the storage compartments 150. These holders 142 are schematically illustrated in FIG. 16 for the sake of simplicity. As can be seen, the exterior side edge of the upwardly-projecting portions 156a will engage the interior edge of the top horizontal member of the C-shaped holders 142 wherever the storage compartment 150 is no longer perfectly aligned with the center. Variants are possible.

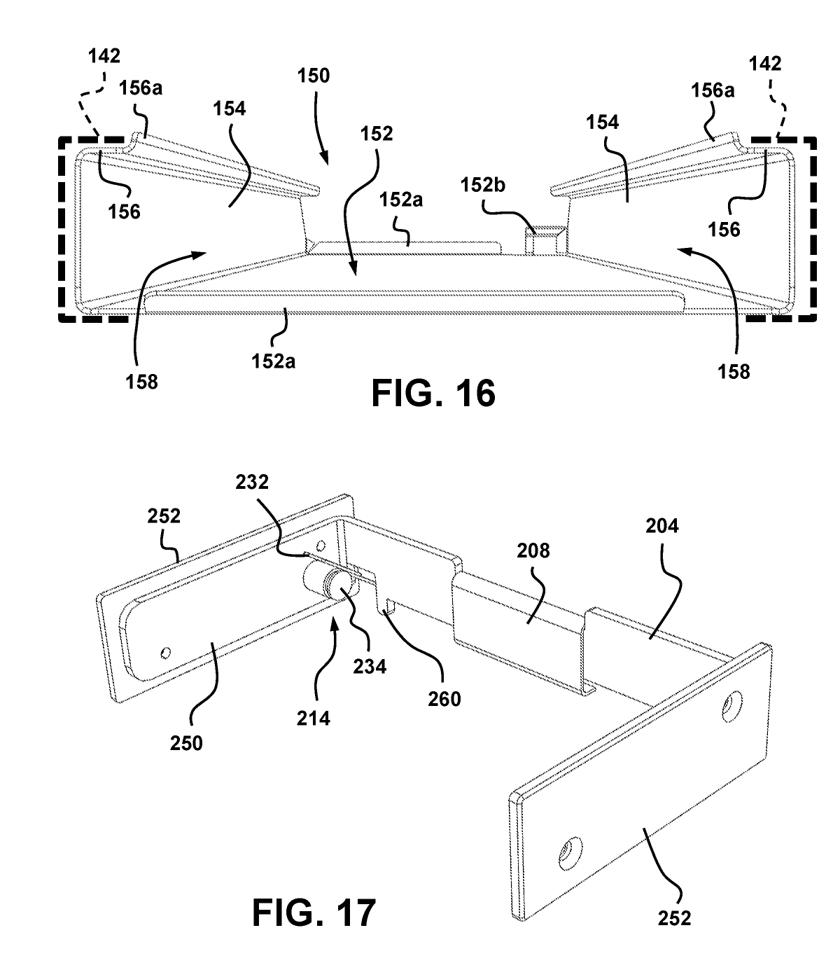

FIG. 17 is an isometric view illustrating the push plate 204 and the one-way locking device 214 of the repositioning system 200 shown in FIG. 14. As can be seen, the push plate 204 is supported at each end by a side portion 250 extending parallel to the corresponding side wall 154. The push plate 204 in the illustrated implementation is formed by the central part of a C-shaped piece oriented towards the front side. Each side portion 250 corresponds to one of the end parts of the C-shaped piece. This C-shaped piece is made of metal and each side portion 250 is attached to a corresponding skid member 252, for instance made of a polymer or another low frictional material, fitting inside a corresponding one of the lateral guiding channels 158 of the storage compartment 150 and in sliding engagement therewith. Variants are possible as well.

As aforesaid, the one-way locking device 214 is provided to incrementally move the push plate 204 towards the foremost edge of the storage compartment 150. Different arrangements are possible. The pull strip 206 in the illustrated implementation includes a plurality of longitudinally spaced-apart and transversally-disposed teeth-like indentations 230 that are provided on the upper surface of the stem of the pull strip 206. The longest part of each indentation 230 faces rearwards. The shorter and steeper part of each indentation 230 is configured and disposed to cooperate with the rear bottom end of a locking pawl 232 that is pivotally connected to the push plate 204. This locking pawl 232 is in the form of a rigid metallic band that is pivotally mounted around an inwardly-projecting peg 234. It thus pivots around a transversal axis. The peg 234 is attached inside the corresponding side portion 250. The center of gravity of the locking pawl 232 is offset towards the rear and as a result, gravity keeps the rear bottom end against the upper surface of the pull strip 206. This arrangement minimizes the number of parts and simplifies cleaning, among other things. Nevertheless, variants are possible as well. For instance, one can use a spring, such as a torsion spring. Other configurations and arrangements are also possible.

In use, when the pull strip 206 is moved forward, the shorter and steeper part of one of the indentations 230 will catch the rear bottom end of the locking pawl 232 and the push plate 204 will be forced to move in the forward direction together with the pull strip 206. Once the push plate 204 is at the right position or if the stroke of the pull strip 206 is at the maximum extended position, the pull strip 206 can be pushed back towards it retracted position. The bottom end of the locking pawl 232 will then simply slide on the upper surface of the pull strip 206.

Reloading an empty or partially empty storage compartment 150 will require the push plate 204 to be moved back towards the rear end of the row. For instance, the locking pawl 232 can be pivoted by pushing down on its upper front end to keep the opposite end out of engagement with the pull strip 206, thereby allowing it to be moved backward along the corresponding storage compartment 150.

The push plate 204 of the illustrated implementation also includes a stopper 208 located at the center thereof. This stopper 208 is C-shaped and its top portion is suspended to the upper edge of a cut-out portion provided at the top center of the push plate 204. The bottom edge of this stopper 208 does not engage the bottom wall 152 but is just above it. The bottom edge of the stopper 208 is configured and disposed to engage the flange 152a located at the rear edge of the storage compartment 150 when the push plate 204 is moved all the way back, thereby preventing it from getting out of the storage compartment 150 unintentionally. The push plate 204 can nevertheless be removed from the storage compartment 150 but this will be possible by slightly lifting the stopper 208, for instance using fingers, and the bottom edge of the stopper 208 will then clear the flange 152a at the rear. The stopper 208 rests by gravity and can be easily removed for cleaning purposes. Other kinds of stoppers can be provided and although it is a convenient feature, the stopper can be omitted in some implementations.

The pull strip 206 is maintained in its longitudinally-extending position by the guiding member 152b located at the front and also by the bottom-projecting tab 260 provided on the push plate 204. The tab 260 borders an opening through which passes the pull strip 206. The interior side of the tab 260 can engage the inner side of the pull strip 206 before it becomes too misaligned. Other arrangements are possible as well.

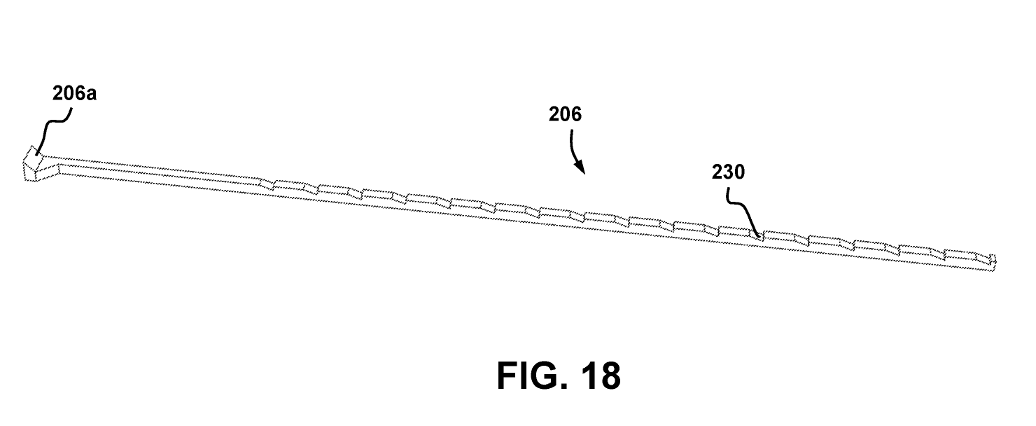

FIG. 18 is an isometric view illustrating the pull strip 206 of the repositioning system 200 shown in FIG. 14.

The pull strip 206 can include means for limiting the stroke distance of the pull strip 206. This way, the pull strip 206 will be prevented from being drawn too far and it will force the attendant to make short back and forth motions to move the push plate 204 towards the foremost edge of the corresponding shelf 140. The limiting means can include for instance two opposite stoppers provided on the pull strip 206, more particularly two stoppers laterally projecting from the sides of a narrower section of the pull strip 206. These stoppers can be configured and disposed to cooperate with opposite blocking features provided on the storage compartment 150. The stroke of the pull strip 206 is preferably limited to be less than half of the length of the pull strip 206. Variants are possible as well.

If desired, a plurality of storage compartment 150 can be grouped side-by-side to form a cassette, for example a group of four compartments that are parallel to one another. The number of compartments and the exact configuration can vary from one implementation to another. The cassette can be preloaded with food tray items 106 and then put on a shelf 140 inside the cabinet 100. It can also be put on the shelf 140 without food tray items 106 therein, and the food tray items 106 can be added afterwards. Other variants are possible as well.

The present detailed description and the appended figures are meant to be exemplary only, and a skilled person will recognize that many changes can be made while still remaining within the proposed concept.

### LIST OF REFERENCE NUMERALS

100 cabinet

102 food tray assembling station

104 food tray

106 food tray item

108 cabinet housing

110 base portion

112 top portion

114 front surface area

120 case

122 caster wheel

124 bottom compartment

130 right shelf section

132 left shelf section

134 right front door

136 left front door

140 shelf

142 C-shaped holder

150 storage compartment

152 bottom wall

152a flange

152b guiding member

154 side wall

156 top ledge

156a upwardly-projecting portion

158 guiding channel

160 auxiliary dispensing unit

162 support

164 articulated arm

166 receptacle

168 central post

170 right peg

172 top wall (of cabinet 100)

174 left peg

180 right rear door

182 left rear door

200 repositioning system

202 food tray item path

204 push plate

206 pull strip

206a knob

208 stopper

210 forward direction

212 rearward direction

214 one-way locking device

220 cassette

230 indentation

232 locking pawl

234 peg

250 side portion

252 skid member

260 tab

What is claimed is:

1. A cabinet for use at a food tray assembly station, the cabinet including:
a cabinet housing having a base portion and a top portion located above the base portion, the top portion including at least one front opening;
a plurality of superposed substantially horizontal shelves provided inside the top portion, each shelf having at least one elongated storage compartment configured to receive a plurality of food tray items that are longitudinally disposed in a single row along a corresponding food tray item path ending at a foremost edge of the shelf;
a repositioning system provided in at least one of the storage compartments, the repositioning system including:
a transversally-disposed push plate that is slidably engaged inside a corresponding one of the storage compartments and that is longitudinally movable along the food tray item path;
an elongated and longitudinally-disposed pull strip that is slidably mounted inside the corresponding one of the storage compartments and that is movable between an extended position and a retracted position; and
a one-way locking device interposed between the push plate and the pull strip to incrementally move the push plate in a forward direction upon moving the pull strip from the retracted position towards the extended position, the one-way locking device bringing the push plate and the pull strip in a force-transmitting engagement only when the pull strip is drawn in the forward direction and automatically releasing the force-transmitting engagement when the pull strip is moved backward towards the retracted position.

2. The cabinet as defined in claim 1, wherein the repositioning system is provided in more than one of the storage compartments inside the cabinet.

3. The cabinet as defined in claim 1, wherein the pull strip is configured and disposed so that in the extended position, a foremost end of the pull strip extends beyond the foremost edge of the storage compartment and, in the retracted position, the foremost end of the pull strip is located within the storage compartment.

4. The cabinet as defined in claim 1, the push plate includes a stopper to prevent the push plate from inadvertently coming out at a rear end of the storage compartment.

5. The cabinet as defined in claim 1, wherein the one-way locking device includes a locking pawl operatively connected to the push pate, the locking pawl having a bottom end engaging one among a plurality of longitudinally spaced-apart and transversally-disposed indentations provided on the pull strip.

6. The cabinet as defined in claim 5, wherein the locking pawl is pivotally mounted on a side of the push plate.

7. The cabinet as defined in claim 1, wherein at least some of the storage compartments are removable from a rear side of the cabinet.

8. The cabinet as defined in claim 1, wherein at least some of the storage compartments include a flat bottom wall, two side walls that are perpendicular to the bottom wall, a front slanted flange and a rear slanted flange.

9. The cabinet as defined in claim 1, further including at least one front door mounted on the cabinet housing, the at least one front door having an opened position and a closed position.

10. The cabinet as defined in claim 9, wherein the at least one door is pivotally attached to the cabinet housing.

11. The cabinet as defined in claim 1, further including at least one rear opening made on a rear side of the top portion.

12. The cabinet as defined in claim 11, further including at least one rear door mounted on the cabinet housing, the at least one rear door having an opened position and a closed position.

13. The cabinet as defined in claim 12, wherein the at least one rear door is pivotally attached to the cabinet housing.

14. The cabinet as defined in claim 1, further including at least one auxiliary dispensing unit that is pivotally attached to the cabinet housing.
